(19) United States
(12) Patent Application Publication
(10) Pub. No.: US 2026/0321585 A1
(43) Pub. Date: Oct. 15, 2026

(54) POSITIVE ELECTRODE PLATE, METHOD FOR PREPARING THE SAME, AND USE THEREOF

(71) Applicant: EVE POWER CO., LTD., Jingmen (CN)

(72) Inventors: Lun JIN, Jingmen (CN); Fanfen LIU, Jingmen (CN); Dingding YUAN, Jingmen (CN); Qingsong LIU, Jingmen (CN); Hang FU, Jingmen (CN); Hongchun ZENG, Jingmen (CN)

(73) Assignee: EVE POWER CO., LTD., Jingmen (CN)

(21) Appl. No.: 19/687,012

(22) Filed: May 25, 2026

Related U.S. Application Data
(63) Continuation of application No. PCT/CN2024/127280, filed on Oct. 25, 2024.

(30) Foreign Application Priority Data
Dec. 14, 2023 (CN) 202311735227.6

(51) Int. Cl. H01M 4/1391; H01M 4/02; H01M 4/04; H01M 4/131; H01M 4/58; H01M 4/62; H01M 10/0525

(52) U.S. Cl. CPC H01M 4/1391; H01M 4/0404; H01M 4/043; H01M 4/131; H01M 4/5825; H01M 4/623; H01M 4/625; H01M 10/0525; H01M 2004/028

(57) ABSTRACT

A positive electrode plate, a method for preparing the same, and a use thereof are provided. The positive electrode plate includes a positive electrode current collector and a positive active material layer that is disposed on at least one surface of the positive electrode current collector. The positive active material layer includes a dispersion aid, lithium iron phosphate, conductive carbon black, and carbon nanotubes, and the dispersion aid, the lithium iron phosphate, the conductive carbon black, and the carbon nanotubes satisfy the following relationship: 30≤(B1×C1+B2×C2+B3×C3)/A×0.01≤500.

This application is a continuation application of International Application No. PCT/CN2024/127280, filed on Oct. 25, 2024, which claims priority to and the benefit of Chinese Patent Application No. 2023117352276, filed on Dec. 14, 2023, the disclosures of which are incorporated herein by reference in their entireties.

### TECHNICAL FIELD

The present disclosure relates to the field of lithium-ion battery technologies, and in particular, to a positive electrode plate, a method for preparing the same, and a use thereof.

### BACKGROUND

Lithium iron phosphate has become the mainstream technical route in the current commercial vehicle and even passenger vehicle fields. It is understood that by the end of 2022, subsidies for new energy vehicles were gradually phased out; thus, how to further reduce the production cost of cells and how to further improve production efficiency have become common challenges faced by cell manufacturers and vehicle manufacturers.

In the existing preparation process of positive electrode plates using lithium iron phosphate, there are drawbacks such as poor stability of the slurry, large consumption of N-methylpyrrolidone (NMP), and proneness to cracking and low peel strength of the prepared positive electrode plates, which result in low energy efficiency and high resistance.

### SUMMARY

In a first aspect, some embodiments of the present disclosure provide a positive electrode plate, which includes a positive current collector and a positive active material layer disposed on at least one surface of the positive current collector. The positive material layer includes a dispersion aid, lithium iron phosphate (LFP), conductive carbon black, and carbon nanotubes (CNTs). The dispersion aid, the lithium iron phosphate, the conductive carbon black, and the carbon nanotubes satisfy the following relationship: 30≤(B1×C1+B2×C2+B3×C3)/A×0.01≤500, where A represents a mass proportion of the dispersion aid in the positive active material layer, B1 represents a specific surface area of the lithium iron phosphate, C1 represents a mass proportion of the lithium iron phosphate in the positive active material layer, B2 represents a specific surface area of the conductive carbon black, C2 represents a mass proportion of the conductive carbon black in the positive active material layer, B3 represents a specific surface area of the carbon nanotubes, and C3 represents a mass proportion of the carbon nanotubes in the positive active material layer.

In a second aspect, some embodiments of the present disclosure provide a method for preparing the above-mentioned positive electrode plate, the method includes the following steps:
mixing a dispersion aid, lithium iron phosphate, conductive carbon black, carbon nanotubes, and a binder in a dry process to obtain a mixture, and adding a solvent to the mixture to obtain a positive electrode slurry; and
coating the positive electrode slurry on a surface of a positive current collector to obtain the positive electrode plate through drying, cold pressing, and die-cutting.

In a third aspect, some embodiments of the present disclosure provide a lithium-ion battery, which includes the above-mentioned positive electrode plate, a negative electrode plate, and an electrolyte.

### BRIEF DESCRIPTION OF THE DRAWINGS

FIG. 1 is a schematic diagram illustrating function of a dispersion aid according to some embodiments of the present disclosure.

### DETAILED DESCRIPTION

Some embodiments of the present disclosure provide a positive electrode plate, which includes a positive current collector and a positive active material layer disposed on at least one surface of the positive current collector. The positive material layer includes a dispersion aid, lithium iron phosphate (LFP), conductive carbon black, and carbon nanotubes (CNTs). The dispersion aid, the lithium iron phosphate, the conductive carbon black, and the carbon nanotubes satisfy the following relationship: 30≤(B1×C1+B2×C2+B3×C3)/A×0.01≤500, where A represents a mass proportion of the dispersion aid in the positive active material layer, B1 represents a specific surface area of the lithium iron phosphate, C1 represents a mass proportion of the lithium iron phosphate in the positive active material layer, B2 represents a specific surface area of the conductive carbon black, C2 represents a mass proportion of the conductive carbon black in the positive active material layer, B3 represents a specific surface area of the carbon nanotubes, and C3 represents a mass proportion of the carbon nanotubes in the positive active material layer.

In the calculation formulas described in the present disclosure, the unit of mass proportion is “%”. For example, if C1=95%, then C1 is calculated as 95 in the calculation formulas.

In the embodiments of the present disclosure, the dispersion aid is added to the positive electrode plate. The actual specific surface area of carbon in the positive active material layer (the specific surface area of LFP, which contains carbon uniformly distributed, thus the specific surface area of carbon in LFP is equal to the specific surface area of LFP, combined with the specific surface area of carbon in conductive agents such as conductive carbon black, CNTs, etc.) and the amount and structure of the dispersion aid added have a synergistic effect on the processing performance and electrical performance of the positive electrode slurry. By integrating the above-mentioned relationships and the characteristics of the dispersion aid, the embodiments of the present disclosure can address the shortcomings such as improving the solid content of the positive electrode slurry during discharge, enhancing the stability of the positive electrode slurry, significantly reducing the consumption of N-methylpyrrolidone (NMP), addressing the problem of cracking of the positive electrode plate in the thick electrode system, and increasing the peel strength of the positive electrode plate. Thereby, it reduces the production cost of cells using the positive electrode plate and improves the production efficiency of the cells. From the perspective of the battery end, it can improve the resistance of the positive electrode plate, reduce the DCR internal resistance, and enhance the rate discharge energy efficiency.

In some embodiments, the chemical structure of the dispersion aid is represented by

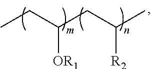

where R₁ is selected from the group consisting of methyl, ethyl, and propyl, and R₂ is selected from the group consisting of a methyl ester group, an ethyl ester group, and a propyl ester group. m ranges from 1 to 3, for example, 1, 2, or 3. n ranges from 1 to 3, for example, 1, 2, or 3.

The dispersion aid of the present disclosure primarily adsorbs or anchors onto the surface of the material, forming a sufficiently thick adsorption layer, and the solvated chains can adopt an extended conformation in NMP. The carbon layer on the surface of LFP, conductive carbon black, and the surface of CNTs all contain a large number of oxygen-containing functional groups such as carboxyl groups, hydroxyl groups, and epoxy groups, which form hydrogen bonding interactions with the alkoxy groups in the dispersion aid. The polyester-based solvated chains in the dispersion aid have good compatibility with NMP, promoting the dispersion aid to stretch in the solvent, enabling the dispersion aid to be coated between various materials (LFP, conductive carbon black, CNTs), forming steric hindrance, preventing agglomeration of various materials, and facilitating intermolecular slipping. This reduces internal friction, decreases viscosity of slurry, and addresses the shortcomings such as improving the solid content during discharge, preventing upward migration of polyvinylidene fluoride (PVDF), and improving cracking of the positive electrode plate during high-speed coating processes.

In some embodiments, the mass proportion of the dispersion aid (A) in the positive active material layer ranges from 0.05% to 0.3%, for example, 0.05%, 0.08%, 0.1%, 0.2%, 0.3%, or the like.

In some embodiments, the specific surface area of the lithium iron phosphate (B1) ranges from 10 m²/g to 20 m²/g, for example, 10 m²/g, 12 m²/g, 15 m²/g, 18 m²/g, 20 m²/g, or the like.

In some embodiments, the mass proportion of the lithium iron phosphate (C1) in the positive active material layer ranges from 95% to 98%, for example, 95%, 95.5%, 96%, 97%, 98%, or the like.

In some embodiments, the lithium iron phosphate has a surface carbon content of 1.0% to 2.5%, for example, 1.0%, 1.2%, 1.5%, 2%, 2.5%, or the like.

In some embodiments, the specific surface area of the conductive carbon black (B2) ranges from 50 m²/g to 150 m²/g, for example, 50 m²/g, 80 m²/g, 100 m²/g, 120 m²/g 150 m²/g, or the like.

In some embodiments, the mass proportion of the conductive carbon black (C2) in the positive active material layer ranges from 0.5% to 2%, for example, 0.5%, 0.8%, 1%, 1.5%, 2%, or the like.

In some embodiments, the specific surface area of the carbon nanotubes (B3) ranges from 200 m²/g to 300 m²/g, for example, 200 m²/g, 220 m²/g, 250 m²/g, 280 m²/g, 300 m²/g, or the like.

In some embodiments, the mass proportion of the carbon nanotubes (C3) in the positive active material layer ranges from 0.1% to 1%, for example, 0.1%, 0.2%, 0.5%, 0.8%, 1%, or the like.

In some embodiments, the positive active material layer further includes a binder.

In some embodiments, the binder includes polyvinylidene fluoride.

Some embodiments of the present disclosure provide a method for preparing the above-mentioned positive electrode plate, the method includes the following steps.

Mix a dispersion aid, lithium iron phosphate, conductive carbon black, carbon nanotubes, and a binder in a dry process to obtain a mixture. Add a solvent to the mixture to obtain a positive electrode slurry.

Coat the positive electrode slurry on a surface of a positive current collector to obtain the positive electrode plate through drying, cold pressing, and die-cutting.

In the preparation process of the positive electrode plate described in the above embodiments of the present disclosure, by ensuring the good dispersion of multiple components (including LFP, conductive carbon black, CNTs, and the binder) in the positive electrode system as well as the good distribution of the conductive agents and the binder, the resistance of the positive electrode plate is increased, the peel strength of the positive electrode plate is enhanced, and further, the DCR internal resistance is reduced and the rate performance is improved.

Some embodiments of the present disclosure provide a lithium-ion battery, which includes the above-mentioned positive electrode plate, a negative electrode plate, and an electrolyte.

In some embodiments, the electrolyte injection amount of the electrolyte in the lithium-ion battery ranges from 4.2 g/Ah to 5.2 g/Ah, for example, 4.2 g/Ah, 4.5 g/Ah, 4.8 g/Ah, 5 g/Ah, 5.2 g/Ah, or the like.

The following specific examples are provided to further illustrate the technical solutions of the present disclosure. Those skilled in the art should understand that the following examples merely for facilitating the understanding of the present disclosure and shall not be regarded as specific limitations on the present disclosure.

In the following examples and comparative examples of the present disclosure, A represents the mass proportion of the dispersion aid in the positive active material layer, B1 represents the specific surface area of the lithium iron phosphate, C1 represents the mass proportion of the lithium iron phosphate in the positive active material layer, B2 represents the specific surface area of the conductive carbon black, C2 represents the mass proportion of the conductive carbon black in the positive active material layer, B3 represents the specific surface area of the carbon nanotubes, and C3 represents the mass proportion of the carbon nanotubes in the positive active material layer.

### Example 1

This example provides a positive electrode plate, which is prepared by the following method.

(1) Mix LFP with a surface carbon content of 2.5%, conductive carbon black, CNTs, the dispersion aid (with a chemical structure represented by

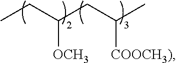

And PVDF in a mass percentage of 95:2:1:0.05:1.7 (i.e., C1:C2:C3:A:(100−(C1+C2+C3+A))=95:2:1:0.05:1.7) to obtain a mixture. Add NMP as a solvent to the mixture to obtain a positive electrode slurry.

(2) Evenly coat the positive electrode slurry onto aluminum foil, and after processes such as drying, cold pressing, and die-cutting, the positive electrode plate is obtained. In this example, B1=20 m²/g, B2=150 m²/g, B3=280 m²/g, and A, B1, B2, B3, C1, C2, and C3 satisfy the following equation: (B1×C1+B2×C2+B3×C3)/A×0.01=496.

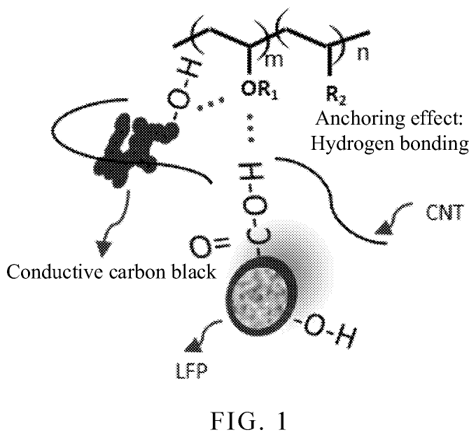

The schematic diagram illustrating the function of the dispersion aid in the positive electrode plate is shown in FIG. 1.

### Example 2

This example provides a positive electrode plate, which is prepared by the following method.

(1) Mix LFP with a surface carbon content of 1.0%, conductive carbon black, CNTs, the dispersion aid (with a chemical structure represented by

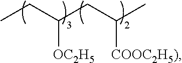

and PVDF in a mass percentage of 97.35:0.5:0.3:0.3:1.5 (i.e., C1:C2:C3:A:(100−(C1+C2+C3+A))=97.35:0.5:0.3:0.3:1.5). Add NMP as a solvent to the mixture to obtain a positive electrode slurry.

(2) Evenly coat the positive electrode slurry onto aluminum foil, and after processes such as drying, cold pressing, and die-cutting, the positive electrode plate is obtained. In this example, B1=10 m²/g, B2=50 m²/g, B3=200 m²/g, and A, B1, B2, B3, C1, C2, and C3 satisfy the following equation: (B1×C1+B2×C2+B3×C3)/A×0.01=35.

The schematic diagram illustrating the function of the dispersion aid in the positive electrode plate is shown in FIG. 1.

### Example 3

This example provides a positive electrode plate, which is prepared by the following method.

(1) Mix LFP with a surface carbon content of 1.8%, conductive carbon black, CNTs, the dispersion aid (with a chemical structure represented by

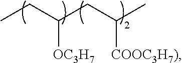

and PVDF in a mass percentage of 96:1:0.5:0.2:2.3 (i.e., C1:C2:C3:A:(100−(C1+C2+C3+A))=96:1:0.5:0.2:2.3) to obtain a mixture. Add NMP as a solvent to the mixture to obtain a positive electrode slurry.

(2) Evenly coat the positive electrode slurry onto aluminum foil, and after processes such as drying, cold pressing, and die-cutting, the positive electrode plate is obtained. In this example, B1=15 m²/g, B2=85 m²/g, B3=240 m²/g, and A, B1, B2, B3, C1, C2, and C satisfy the following equation: (B1×C1+B2×C2+B3×C3)/A×0.01=82.

The schematic diagram illustrating the function of the dispersion aid in the positive electrode plate is shown in FIG. 1.

### Example 4

The only difference between this example and Example 3 is that B1=10 m²/g, B2=180 m²/g, B3=320 m²/g, and A, B1, B2, B3, C1, C2, and C3 satisfy the following equation: (B1×C1+B2×C2+B3×C3)/A×0.01=65. All other conditions and parameters are identical to those in Example 3.

### Example 5

The only difference between this example and Example 3 is that B1=25 m²/g, B2=40 m²/g, B3=150 m²/g, and A, B1, B2, B3, C1, C2, and C3 satisfy the following equation: (B1×C1+B2×C2+B3×C3)/A×0.01=125. All other conditions and parameters are identical to those in Example 3.

### Example 6

The only difference between this example and Example 3 is that B1=15 m²/g, B2=100 m²/g, B3=150 m²/g, and A, B1, B2, B3, C1, C2, and C3 satisfy the following equation: (B1×C1+B2×C2+B3×C3)/A×0.01=80. All other conditions and parameters are identical to those in Example 3.

### Example 7

The only difference between this example and Example 3 is that B1=15 m²/g, B2=40 m²/g, B3=250 m²/g, and A, B1, B2, B3, C1, C2, and C3 satisfy the following equation: (B1×C1+B2×C2+B3×C3)/A×0.01=80. All other conditions and parameters are identical to those in Example 3.

### Comparative Example 1

The only difference between this comparative example and Example 1 is that A, B1, B2, B3, C1, C2, and C3 satisfy the following equations: C1:C2:C3:A:100−(C1+C2+C3+A)=94:2.5:0.5:0.03:2.6, and (B1×C1+B2×C2+B3×C3)/A×0.01=987, where B1=25 m²/g, B2=180 m²/g, B3=320 m²/g. All other conditions and parameters are identical to those in Example 1.

### Comparative Example 2

The only difference between this comparative example and Example 1 is that A, B1, B2, B3, C1, C2, and C3 satisfy the following equations: C1:C2:C3:A:100−(C1+C2+C3+A)=98.47:0.3:0.2:0.4:1, and (B1×C1+B2×C2+B3×C3)/A×0.01=7, where B1=6 m²/g, B2=35 m²/g, B3=150 m²/g. All other conditions and parameters are identical to those in Example 1.

### Comparative Example 3

The only difference between this comparative example and Example 1 is that no dispersion aid is added. All other conditions and parameters are identical to those in Example 1.

### Performance Testing:

(1) Record the solid content and the viscosity of the positive electrode slurry during the preparation of positive electrode plates in the example and comparative examples, as well as the peel strength of the positive electrode plates after cold pressing and the resistance of the positive electrode plates.

(2) Mix graphite, CMC, SBR, and conductive carbon black in a mass ratio of 96:1.5:1.5:1. Add deionized water as a solvent and stir the materials until uniformly mixed. Coat the mixture onto copper foil, then proceed with drying, cold pressing, and die-cutting to obtain the positive electrode plate. Stack each of the positive electrode plates prepared from the examples and comparative examples, a separator (using Enjie 12 μm separator), and the negative electrode plate in sequence, ensuring the separator is positioned between the positive electrode plate and the negative electrode plate to provide isolation. Then, a jelly core is obtained by using a lamination process or a winding process. Place the jelly core into an outer packaging case (such as an aluminum case or a soft package). After drying, inject the electrolyte (selecting Sinochem Lantian ZP507 type) according to the electrolyte injection amount specified in the present disclosure. Proceed with vacuum packaging, standing, formation, and capacity grading processes to obtain a secondary battery. Conduct the following electrical performance testing on the secondary battery.
1) HPPC Test at 25° C.
a, Cycle the cell at 0.5 C/0.5 C for 5 weeks at 25±2° C.
b, Let the cell stand for 24 hours at 25±2° C.
c, Discharge at a constant current of 1.0 C for 10 seconds, then let the cell stand for 1 minute.
d, Adjust the state of charge (SOC) at 0.2 C, then let the cell stand for 1 hour.
e, Charge at a constant current of 1.0 C for 10 seconds, then let the cell stand for 1 minute.
f, Discharge DCR Calculation: After adjusting the SOC, let the cell stand for 1 hour, and record the terminal voltage as VD₀. Discharge at a constant current of 1.0 C for 10 seconds, and record the terminal voltage as VD₁₀.
g, Calculate the DCR at 50% SOC using the formula: DCR=(VD₀−VD₁₀)/I.
2) Discharge Performance at 25° C.
a, Let the battery stand for 10 minutes at 25±2° C., then cycle it at 0.5 C/0.5 C for 5 weeks.
b, Charge the battery using a constant current and constant voltage method at 0.5 C.
c, Let the battery rest for 10 minutes at 25±2° C.
d, Discharge the battery at a 3 C current until the battery voltage reaches 2.0 V, then stop discharging.
e, Record the discharge energy efficiency of the cell. The test results are shown in Table 1.

TABLE 1

| | Solid | | | | | |
|---|---|---|---|---|---|---|
| | content | | | | | |
| | of | Viscosity | | | | |
| | positive | of positive | Peel strength | Resistance | | 3 C Energy |
| | electrode | electrode | after cold | of positive | DCR 50% SOC | efficiency |
| | slurry | slurry | pressing | electrode | at 25 °C | at 25 °C |
| | (%) | (mPa · s) | (N/30 mm) | plate (Ω) | (mΩ) | (%) |
| Example 1 | 68.2 | 12000 | 0.42 | 0.29 | 36.5 | 81.4 |
| Example 2 | 69.8 | 13500 | 0.44 | 0.30 | 38.0 | 80.2 |
| Example 3 | 68.7 | 11050 | 0.46 | 0.26 | 34.7 | 83.0 |
| Example 4 | 68.8 | 13150 | 0.25 | 0.43 | 43.4 | 77.4 |
| Example 5 | 68.5 | 12050 | 0.29 | 0.35 | 38.4 | 80.5 |
| Example 6 | 68.2 | 12000 | 0.33 | 0.42 | 41.0 | 79.9 |
| Example 7 | 68.8 | 12850 | 0.37 | 0.39 | 39.8 | 80.2 |
| Comparative | 64.0 | 11850 | 0.26 | 0.45 | 44.8 | 76.0 |
| Example 1 | | | | | | |
| Comparative | 68.4 | 14050 | 0.21 | 0.52 | 48.5 | 74.7 |
| Example 2 | | | | | | |
| Comparative | 61.8 | 13000 | 0.27 | 0.46 | 43.4 | 76.8 |
| Example 3 | | | | | | |

As shown in Table 1, from Examples 1-3, it can be concluded that in the preparation process of the positive electrode plate described in the present disclosure, the solid content of the positive electrode slurry can reach over 68.2%, with the viscosity controlled within 13,500 mPa·s. After the cold pressing process, the peel strength can reach over 0.42 N/mm, and the resistance of the positive electrode plate can be as low as 0.3Ω. The battery made from this positive electrode plate can achieve a 50% SOC DCR of less than 38 mΩ at 25° C., and a 3 C energy efficiency of over 80.2% at 25° C. This positive electrode plate does not use additional conductive agents, significantly reducing the dispersion time of the positive electrode slurry, lowering production costs, and improving production efficiency. The secondary battery exhibits better performance in terms of 3 C rate charge-discharge performance at room temperature, high-temperature storage, and long cycle life at high temperatures.

From the comparison between Example 3 and Examples 4-7, it can be concluded that in the positive electrode plate described in the present disclosure, the specific surface area of lithium iron phosphate (B1), the specific surface area of conductive carbon black (B2), and the specific surface area of carbon nanotubes (B3) affects its performance. Controlling B1 within 10-20 m²/g, B2 within 50-150 m²/g, and B3 within 200-300 m²/g results in better performance of the positive electrode plate. If these values fall outside the specified ranges, the performance of the positive electrode plate will noticeably and variably decline.

From the comparison between Example 1 and Comparative Examples 1-2, it can be concluded that the present disclosure achieves optimal performance by reasonably adjusting the proportion and the specific surface area of LFP, the proportion and the specific surface area of the conductive agent, and the amount of dispersion aid added. This ensures that multiple characteristic parameters meet specific relationships, promoting the dispersion of multi-component materials, maintaining a good conductive network and adhesive distribution, enhancing peel strength, and reducing the resistance of the positive electrode plate. As a result, the DCR internal resistance is lowered, and the rate discharge energy efficiency is improved.

From the comparison between Example 1 and Comparative Example 3, it can be concluded that the dispersion aid of the present disclosure primarily adsorbs or anchors onto the surface of the material, forming a sufficiently thick adsorption layer, and the solvated chains can adopt an extended conformation in NMP. The carbon layer on the surface of LFP, conductive carbon black, and the surface of CNTs all contain a large number of oxygen-containing functional groups such as carboxyl groups, hydroxyl groups, and epoxy groups, which form hydrogen bonding interactions with the alkoxy groups in the dispersion aid. The polyester-based solvated chains in the dispersion aid have good compatibility with NMP, promoting the dispersion aid to stretch in the solvent, enabling the dispersion aid to be coated between various materials (LFP, conductive carbon black, CNTs), forming steric hindrance, preventing agglomeration of various materials, and facilitating intermolecular slipping. This reduces internal friction, decreases viscosity of slurry, and addresses the shortcomings such as improving the solid content during discharge, preventing upward migration of PVDF, and improving cracking of the electrode plate during high-speed coating processes.

What is claimed is:

1. A positive electrode plate, comprising a positive current collector and a positive active material layer disposed on at least one surface of the positive current collector, wherein the positive active material layer comprises a dispersion aid, lithium iron phosphate, conductive carbon black, and carbon nanotubes, and the dispersion aid, the lithium iron phosphate, the conductive carbon black, and the carbon nanotubes satisfy the following relationship:
30≤(B1×C1+B2×C2+B3×C3)/A×0.01≤500;
wherein A represents a mass proportion of the dispersion aid in the positive active material layer, B1 represents a specific surface area of the lithium iron phosphate, C1 represents a mass proportion of the lithium iron phosphate in the positive active material layer, B2 represents a specific surface area of the conductive carbon black, C2 represents a mass proportion of the conductive carbon black in the positive active material layer, B3 represents a specific surface area of the carbon nanotubes, and C3 represents a mass proportion of the carbon nanotubes in the positive active material layer.

2. The positive electrode plate according to claim 1, wherein a chemical structure of the dispersion aid is represented by the following formula: 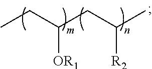
wherein R₁ is selected from a group consisting of methyl, ethyl, and propyl, R₂ is selected from a group consisting of a methyl ester group, an ethyl ester group, and a propyl ester group, m ranges from 1 to 3, and n ranges from 1 to 3.

3. The positive electrode plate according to claim 1, wherein A ranges from 0.05% to 0.3%.

4. The positive electrode plate according to claim 1, wherein B1 ranges from 10 m²/g to 20 m²/g.

5. The positive electrode plate according to claim 1, wherein C1 ranges from 95% to 98%.

6. The positive electrode plate according to claim 1, wherein the lithium iron phosphate has a surface carbon content of 1.0% to 2.5%.

7. The positive electrode plate according to claim 1, wherein B2 ranges from 50 m²/g to 150 m²/g.

8. The positive electrode plate according to claim 1, wherein C2 ranges from 0.5% to 2%.

9. The positive electrode plate according to claim 1, wherein B3 ranges from 200 m²/g to 300 m²/g.

10. The positive electrode plate according to claim 1, wherein C3 ranges from 0.1% to 1%.

11. The positive electrode plate according to claim 1, wherein A ranges from 0.05% to 0.3%, B1 ranges from 10 m²/g to 20 m²/g, B2 ranges from 50 m²/g to 150 m²/g, C2 ranges from 0.5% to 2%, B3 ranges from 200 m²/g to 300 m²/g, and C3 ranges from 0.1% to 1%, wherein the lithium iron phosphate has a surface carbon content of 1.0% to 2.5%.

12. The positive electrode plate according to claim 1, wherein the positive active material layer further comprises a binder.

13. The positive electrode plate according to claim 11, wherein the binder comprises polyvinylidene fluoride.

14. A method for preparing a positive electrode plate, comprising the following steps:
mixing a dispersion aid, lithium iron phosphate, conductive carbon black, carbon nanotubes, and a binder in a dry process to obtain a mixture, and adding a solvent to the mixture to obtain a positive electrode slurry; wherein the dispersion aid, the lithium iron phosphate, the conductive carbon black, and the carbon nanotubes satisfy the following relationship: 30≤(B1×C1+B2×C2+B3×C3)/A×0.01≤500, wherein A represents a mass proportion of the dispersion aid in the positive active material layer, B1 represents a specific surface area of the lithium iron phosphate, C1 represents a mass proportion of the lithium iron phosphate in the positive active material layer, B2 represents a specific surface area of the conductive carbon black, C2 represents a mass proportion of the conductive carbon black in the positive active material layer, B3 represents a specific surface area of the carbon nanotubes, and C3 represents a mass proportion of the carbon nanotubes in the positive active material layer; and
coating the positive electrode slurry on a surface of a positive current collector to obtain the positive electrode plate through drying, cold pressing, and die-cutting.

15. A lithium-ion battery comprising a positive electrode plate, a negative electrode plate, and an electrolyte, wherein the positive electrode plate comprises a positive current collector and a positive active material layer disposed on at least one surface of the positive current collector, and the positive active material layer comprises a dispersion aid, lithium iron phosphate, conductive carbon black, and carbon nanotubes, and the dispersion aid, the lithium iron phosphate, the conductive carbon black, and the carbon nanotubes satisfy the following relationship:
30≤(B1×C1+B2×C2+B3×C3)/A×0.01≤500;
wherein A represents a mass proportion of the dispersion aid in the positive active material layer, B1 represents a specific surface area of the lithium iron phosphate, C1 represents a mass proportion of the lithium iron phosphate in the positive active material layer, B2 represents a specific surface area of the conductive carbon black, C2 represents a mass proportion of the conductive carbon black in the positive active material layer, B3 represents a specific surface area of the carbon nanotubes, and C3 represents a mass proportion of the carbon nanotubes in the positive active material layer.

16. The lithium-ion battery according to claim 15, wherein an electrolyte injection amount of the electrolyte in the lithium-ion battery ranges from 4.2 g/Ah to 5.2 g/Ah.

17. The lithium-ion battery according to claim 15, wherein a chemical structure of the dispersion aid is represented by the following formula: 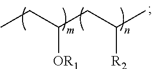
wherein R₁ is selected from a group consisting of methyl, ethyl, and propyl, R₂ is selected from a group consisting of a methyl ester group, an ethyl ester group, and a propyl ester group, m ranges from 1 to 3, and n ranges from 1 to 3.

18. The lithium-ion battery according to claim 15, wherein A ranges from 0.05% to 0.3%, B1 ranges from 10 m²/g to 20 m²/g, B2 ranges from 50 m²/g to 150 m²/g, C2 ranges from 0.5% to 2%, B3 ranges from 200 m²/g to 300 m²/g, and C3 ranges from 0.1% to 1%.

19. The lithium-ion battery of claim 15, wherein the lithium iron phosphate has a surface carbon content of 1.0% to 2.5%.

20. The lithium-ion battery of claim 15, wherein the binder comprises polyvinylidene fluoride.
